(19) United States
(12) Patent Application Publication
(10) Pub. No.: US 2005/0094984 A1
(43) Pub. Date: May 5, 2005

(54) Device for processing a content signal that represents a content in accordance with a specific type of content comprising data carrier means for in putting content-type selection information

(76) Inventors: Johannes Peter Schramel, Vienna (AT); Walter Weissensteiner, Vienna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/506,281

(22) PCT Filed: Feb. 12, 2003
(86) PCT No.: PCT/IB03/00564

(30) Foreign Application Priority Data
Mar. 5, 2002 (EP) 02100220.9

(51) Int. Cl. H04N 5/90

(52) U.S. Cl. 386/125

(57) ABSTRACT

A device (1) for processing a content signal (CS) that represents a content in accordance with a specific type of content is provided with receiving means (8) which are designed in an adjustable manner for receiving, with the aid of content-type selection information (CSI) that can be input into the device (1), a content signal (CS), the content type of which corresponds to the input content-type selection information (CSI), for the purpose of inputting the content-type selection information (CSI) there being provided data-carrier accessing means (11) which are designed for accessing content-type selection information (CSI) stored in a data carrier (2) that can be made accessible to the data-carrier accessing means (11).

The invention relates to a device which is designed for processing a content signal that represents a content in accordance with a specific type of content and is equipped with receiving means which are designed in an adjustable manner for receiving, with the aid of content-type selection information enabling the selection of a type of content, the content signal that represents a content, the type of which corresponds to the content-type selection information, and is equipped with inputting means which are designed for inputting the content-type selection information for the purpose of adjusting the receiving means.

The invention further relates to a data carrier in which accessible information is stored.

The invention further relates to a method for making available content-type selection information in a device for processing a content signal that represents a content that is assigned to a specific content type, the method comprising the steps listed below: receipt of content-type selection information which can be input with the aid of inputting means on the device, a content signal being receivable in an adjustable manner by receiving means on the device with the aid of content-type selection information that can be input, which content signal represents a content, the type of which corresponds to the content-type selection information.

A device of this kind as set forth in the first paragraph, and a data carrier of this kind as set forth in the second paragraph, and a method of this kind as set forth in the third paragraph are known from the patent document EP 0 813 302 A1.

The known device with which the known method can be implemented and which is equipped with the known data carrier is a portable device for receiving a content signal, where the received content signal can each time be assigned to a specific content type. The known device enables a user to enjoy, acoustically or visually, a content type preferred by him, without any knowledge being required of him concerning an assignment between a transmission channel or a transmission frequency band or a transmission time of a content signal and the content type preferred by him. This assignment is stored in the known device with the aid of the known data carrier. The known device is equipped with inputting means that can be operated by a user, with the aid of which inputting means content-type selection information can be input by the user of the device for selecting a content type preferred by the user.

With the known device, the problem exists that the content-type selection information has to be input in a relatively complicated, laborious manner by the user of the device with the aid of the operator-controllable inputting means. This is disadvantageous since a mistake may occur when inputting into the device, leading to the device malfunctioning or failing to operate at all. It should further be stated that, if the known device is used in a motor vehicle, the problem may occur that, as the result of maloperation, a user of the device repeatedly attempts to input content-type selection information, as a result of which the user's attention is diverted from the traffic situation.

It is an object of the invention to eliminate the problems cited above in a device of the kind set forth in the first paragraph and a method of the kind set forth in the second paragraph, and a data carrier of kind set forth in the third paragraph, and to create an improved device and an improved data carrier and an improved method.

To achieve the object cited above, in accordance with the invention, the inputting means in a device of the kind set forth in the first paragraph contain data-carrier accessing means that are designed to interact with a data carrier and, for the purpose of inputting the content-type selection information into the device, are designed for accessing content-type selection information stored in a data carrier that can be made accessible to the data-carrier accessing means.

To achieve the object cited above, in accordance with the invention in a data carrier of the kind set forth in the second paragraph at least parts of the stored information form content-type selection information which, when the data carrier is made accessible to data-carrier accessing means of a device for processing a content signal, can be accessed with the aid of the data-carrier accessing means for the purpose of inputting the content-type selection information into the device.

To achieve the object cited above, in accordance with the invention a method of the kind set forth in the third paragraph for the purpose of inputting the content-type selection information with the aid of the data-carrier accessing means of the device, content-type selection information stored in a data carrier that can be made accessible to the data-carrier accessing means, is accessed.

Through the provision of the measures in accordance with the invention, it is achieved in an advantageous manner that content-type selection information can be input by a user in a very simple manner, while avoiding the possibility of maloperation by a user. Furthermore, the advantage is obtained that, depending on the particular data carrier made accessible to the data-carrier accessing means of the device, and on the content-type selection information stored in the data carrier, an unambiguous inputting of the content-type selection information and, primarily, one that can be reproduced free from errors, is ensured.

In a solution in accordance with the invention, it has further proved advantageous if the data-carrier accessing means are designed to recognize identification data stored on the data carrier, which identification data is provided for marking the content-type selection information. This gives rise to the advantage that the content-type selection information stored in a data carrier can be unambiguously identified.

In a solution in accordance with the invention, it has further proved advantageous if the data-carrier accessing means are designed for accessing content-type selection information stored in an identification-data area of the data carrier, the identification-data area being provided for identifying the data carrier. This give rise to the advantage that, as soon as the data carrier is made accessible to the data-carrier accessing means, the existence of content-type selection information can be established in the course of an identification of the data carrier.

In a solution in accordance with the invention, it has further proved advantageous if the data-carrier accessing means are designed for accessing reminder information assigned to an item of content-type selection information, which reminder information is stored, additionally to the content-type selection information, in a data carrier that can be made accessible to the data-carrier accessing means and represents a part of a content type, the part of the content type already having been received by the receiving means, using the content-type selection information, with the aid of a content signal which represents a content, the content type of which corresponded to the content-type selection information and if the receiving means are designed, taking account of the reminder information, for receiving a content signal, the content type of which corresponds to the content-type selection information. This gives rise to the advantage that, for example in the case where a content signal has as its content an episode from a series of a television or radio program comprising several episodes, it can be reliably ensured that it is always the latest episode that is received and that an unwanted reception of repeats of an episode already received in the past can be avoided.

In a solution in accordance with the invention, it has further proved advantageous if the receiving means are equipped with a receiving stage which is designed in an adjustable manner for receiving a content signal, with the aid of an adjusting signal that can be fed to it, and if the receiving means are equipped with an adjusting stage, which is designed for generating and delivering the adjusting signal for the receiving stage, with the aid of content-type selection information and content-type information that can be fed to it, the content-type information representing a content type of a content signal that can be received with the aid of the receiving stage. This gives rise to the advantage that a reliable adjustment of the receiving stage takes place, taking account of the actually present content type of a content signal that can be received with the aid of the receiving stage.

In a solution in accordance with the invention, it has further proved advantageous if content information can be fed to the adjusting stage with the aid of a content signal that can be received. This gives rise to the advantage that the assignment of a content signal to a specific content type can be undertaken on the basis of the content signal received in each case. This gives rise to the further advantage that the adjustment of the receiving stage for the purpose of receiving a content signal, the content type of which corresponds to the content-type selection information, can be undertaken by testing all content signals that can be received in respect of their actual content type, and by selecting a content signal that is preferred in respect of its content type.

In a solution in accordance with the invention, it has further proved advantageous if a communication stage is assigned to the receiving means, which communication stage is designed for communicating with a content-type information data source, the content-type information data source being provided for supplying content-type information, and which is designed for feeding content-type information supplied by the content-type information data source to the adjusting stage as a result of a communication with the content-type information data source. This gives rise to the advantage that the assignment of a content signal to a specific content type can be ascertained irrespective of the content signal being received at the moment or of a content signal that can currently be received.

In a solution in accordance with the invention, it has further proved advantageous if recording means are provided, with the aid of which, taking account of a recording control signal, a recording can be made in a controllable manner of a content signal that can be received with the aid of the receiving means, and if the receiving means are designed for generating and delivering the recording control signal to the recording means if the content type of the content of the content signal received corresponds to the content-type selection information. This gives rise to the advantage that a recording of a content signal can be undertaken only if the content type of the content signal received corresponds to the content-type selection information which is stored in a data carrier made accessible to the data-carrier accessing means.

In a solution in accordance with the invention, it has further proved advantageous if the recording means are realized by the data-carrier accessing means, and if the data-carrier accessing means are designed for recording the content signal on a data carrier that can be made accessible to them. This gives rise to the advantage that a recording of a content signal on a data carrier containing the content-type selection information can be undertaken if the content type of the content signal received corresponds to the content-type selection information. This further gives rise to the advantage that the recording of a content signal assigned to a content type that is not wanted by the user of a device or by a manufacturer of the data carrier or by a sales or rental company that sells or rents out the data carrier to the user of the device can be avoided in a reliable manner. This further gives rise to the advantage that an unintentional or undesired overwriting of a content signal already recorded on the data carrier, which content signal is assigned to a specific—preferred or predefined—content type, with a content signal, the content type of which does not correspond to the specific content type, can be avoided in a reliable manner even in the event that the user mistakenly commands, either manually or in a voice-controlled manner, a recording of this content signal not corresponding in respect of its content type with the specific content type. This further gives rise to the advantage that, for example, the recording of episodes of a series can be undertaken without intervention by a user, particularly avoiding a timer programming operation which is normally laborious for the user and also usually complex and susceptible to error.

The aspects cited above and further aspects of the invention are illustrated and explained by the embodiments described below.

The invention will be further described with reference to two embodiments shown in the drawings, to which, however, the invention is not restricted.

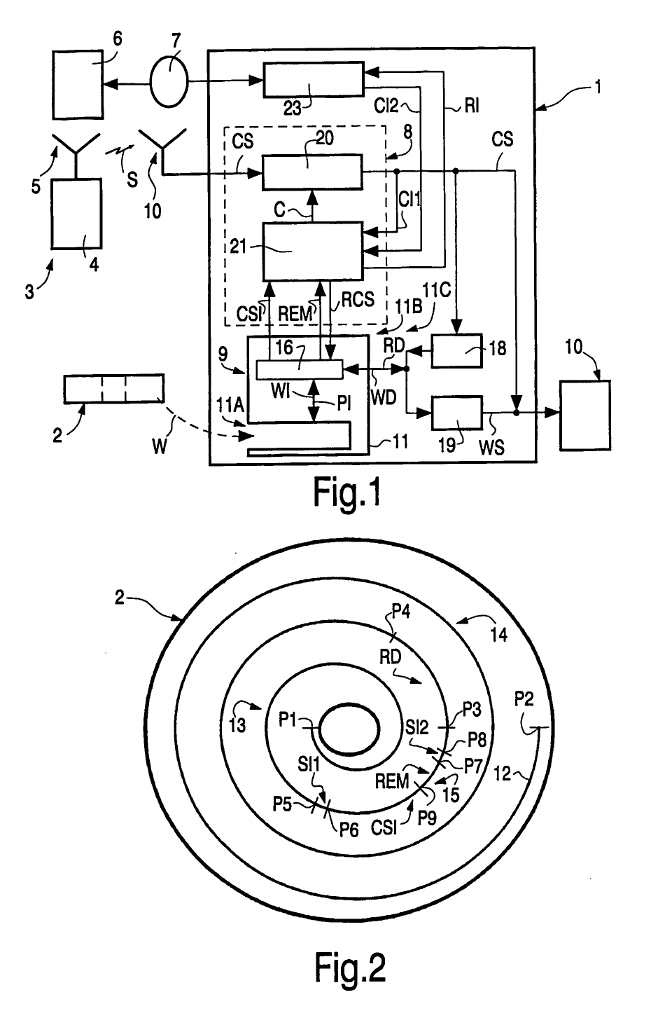

FIG. 1 shows, in the form of a block diagram, a device in accordance with a first embodiment of the invention.

FIG. 2 shows, in a schematic manner, a data carrier that can be scanned in an optical manner and can be used in the device in accordance with FIG. 1.

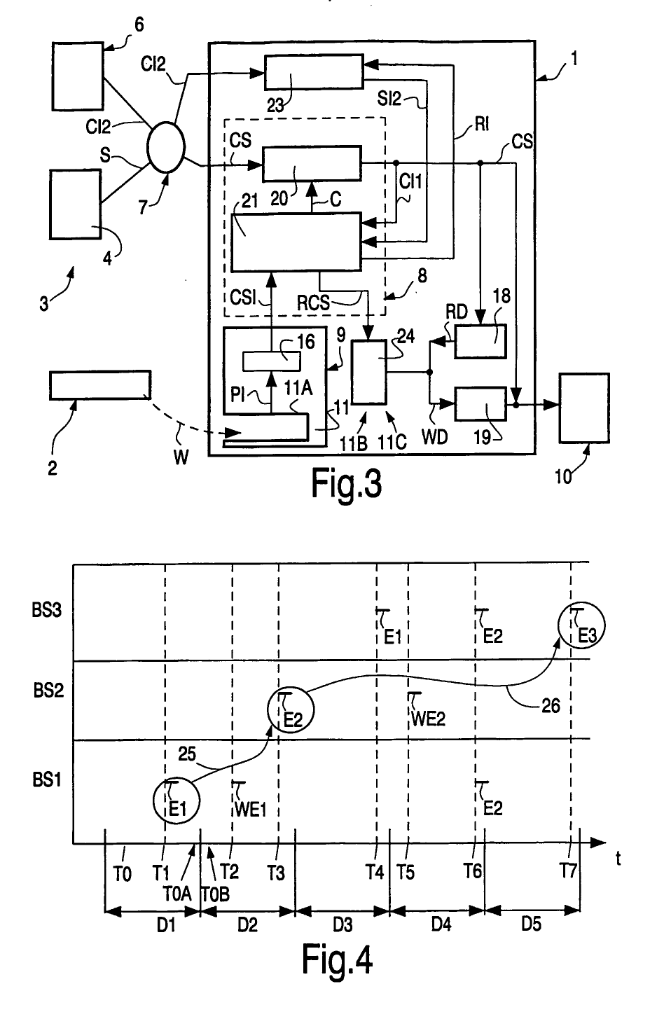

FIG. 3 shows, in a manner analogous to FIG. 1, a device in accordance with a second embodiment of the invention.

FIG. 4 shows, in the form of a diagram, a program plan of three different broadcasting stations for a television series.

FIG. 1 shows a device 1, which is designed for processing a content signal CS that represents a content in accordance with a specific type of content, which content signal CS can be received and/or reproduced and, if applicable, can also be stored. Specifically, the device 1 realizes a digital versatile disc video recorder, so that, with the aid of the device 1, a video film can be recorded on a data carrier 2 in accordance with the invention, formed by a digital versatile disc (DVD), or a video film recorded on a data carrier 2 of this kind can be played back.

A video film can be broadcast with the aid of a transmission signal S from a broadcasting station 3, is equipped for this purpose with a transmission device 4 and a transmission-antenna configuration 5 connected to the transmission device. A transmission channel or a transmission frequency band is assigned to the transmission signal S. The transmission signal S exhibits a content signal CS, which represents a content (i.e. a video film) in accordance with a specific type of content, which content signal CS is broadcast at a specific transmission time. Depending on the video film being broadcast at a given time, the type of content, i.e. the particular genre to which the video film can be assigned, is defined, such as a western, science fiction, scientific, news and so forth. It should be mentioned that the term “type of content” may also relate to a series of video films that can be assigned to one another, such as “The Star Wars Trilogy” or “The Lord of the Rings”, so the content signal CS may represent an episode, i.e. a part of the content, that is an individual video film from a series. It should be mentioned that the term “type of content” may also relate to an actor appearing in a group of video films, or to a plurality of actors appearing in a group of video films; the individual video films of a group of this kind can then be assigned to the most diverse topic areas. It should further be mentioned that the term “video film” should be understood as meaning any unit of audiovisual information that can be broadcast by the broadcasting station 3, i.e. including periodically or non-periodically broadcast lifestyle programs or recordings such as the “Telebörse on NTV” or “The Evening News on RTL”.

Furthermore, the transmission signal S may exhibit, in addition to the content signal CS, a first item of content-type information CI1, which indicates the type of content to which the content of the content signal CS is assigned.

It should be mentioned at this point that the broadcasting station 3 is shown in FIG. 1 to represent a plurality of broadcasting stations; it goes without saying for the expert that, simultaneously with the signal S assigned to broadcasting station 3, a plurality of signals assigned to other broadcasting stations can be broadcast from each of these broadcasting stations, so that, simultaneously on different transmission channels, content signals are broadcast, the contents of which can be assigned to one content type or to different content types.

FIG. 1 also shows a content-type information data source 6, which is realized with the aid of a server provided for storing or for supplying, on request, a second item of content-type information CS, which enables assignment between a transmission channel or a transmission frequency band and a transmission time on the one hand, and a content signal CS on the other for a specific type of content. The content-type information data source 6 is further designed for communicating via a data network 7 connected to it, via which data network 7 a request information RI can be fed to the content-type information data source 6 to request the second content-type information CI2, the request information RI essentially representing the type of content, for which type of content the assignment cited above is to be requested. The content-type information data source 6 is further designed for delivering the requested second content-type information CI2 via the data network 7. The data network 7 is realized by the Internet in the present case. It should, however, be mentioned that any other network suitable for data communication may also be used.

The device 1 is equipped with receiving means 8 and inputting means 9, further details of which means 8 and 9 are given below.

The receiving means 8 are designed in an adjustable manner for receiving, with the aid of a content-type selection information CSI enabling the selection of a type of content, the content signal CS, which represents a content, the content type of which corresponds to the content-type selection information CSI. To this end, the receiving means 8 are connected to a receiving-antenna configuration 10, with the aid of which the transmission signal S that can be broadcast from the transmission-antenna configuration 5, can be fed to the receiving means 8. The receiving means 8 are further designed for receiving the content-type selection information CSI from the inputting means 9. Further, the receiving means 8 are connected to a reproduction means 10, so that the content signal CS contained in the transmission signal S that can be received can be delivered to the reproduction means 10. The reproduction means 10 is designed for reproducing the content signal CS, and is realized in the present case by a television set connected to the device 1. It should, however, be mentioned that the reproduction means 10 may also be formed by a component of the device 1.

The inputting means 9 are designed for inputting the content-type selection information CSI and for delivering the input content-type selection information CSI to the receiving means 8 for the purpose of adjusting the receiving means 8. In accordance with the invention, the inputting means 9 contain data-carrier accessing means 11, which are designed for interacting with the data carrier 2, and which, for the purpose of inputting the content-type selection information CSI into device 1, are designed for accessing the content-type selection information CSI that is stored in the data carrier 2, which can be made accessible to the data-carrier accessing means 11.

The data carrier 2 in accordance with the invention, as shown in detail in FIG. 2, is designed for storing information along a track 12 between a first point P1 of track the 12 and a second point P2 of the track 12, which information can be recorded or read in an optical manner along the track 12. Accordingly, access can be had to the information stored in data carrier 2 by optical scanning of the data carrier 2. The track 12 is essentially divided into an identification-data area 13 and a recording-data area 14, the two areas 13 and 14 being separated from each other by a third point P3. The recording-data area 14 is provided for storing recording data RD which represents the content signal CS, for example, a video film. The identification-data area 13 is provided for storing identification data which is provided for identifying the data carrier 2 or for identifying and locating the recording data RD stored on data carrier 2. In the present case, recording data RD representing a video film has already been recorded on the data carrier 2 between the third point P3 and a fourth point P4.

In accordance with the invention, at least one part of the stored information forms a content-type selection information CIS, to which, when the data carrier 2 is made accessible to the data-carrier accessing means 11 of the device 1, shown in FIG. 1, for processing a content signal CS, access can be had, with the aid of data-carrier accessing means 11, for the purpose of inputting the content-type selection information CSI into the device 1 by optical scanning of the track 12. The content-type selection information CSI is stored in the identification-data area 13. It should, however, be mentioned that the content-type selection information CSI may also be stored in the recording-data area 14 or partly in the identification-data area 13 and partly in the recording-data area 14.

In the data carrier 2 are further stored first identification data SI1 and second identification data SI2, which are provided for marking the content-type selection information CSI. The first identification data S11 is stored between a fifth point P5 and a sixth point P6 along the track 12 within the identification-data area 13, and marks a start of the content-type selection information CSI. The second identification data S12 is stored between a seventh point P7 and an eighth point P8 along the track 12 within the identification-data area 13, and marks an end of the content-type selection information CSI.

The data carrier 2 is provided with a reminder-data area 15, which is located between a ninth point P9 and the seventh point P7 along the track 12 within the identification-data area 13. The reminder-data area 15 is provided for storing reminder information REM, which represents a part of a type of content, which part of the type of content has already been received in the past, with the aid of the content-type selection information CSI stored on the data carrier 2, by the receiving means 8 of the device 1, as shown in FIG. 1, with the aid of a content signal CS, which represents a content, the content type of which corresponded to the content-type selection information CSI stored in the data carrier 2. These circumstances should not be confused with a directory of the data carrier 2 that is sufficiently well known to the expert, and therefore not shown in FIG. 1, which directory is known to represent the content of the recording data RD currently stored on the data carrier 2; in the present case, no further details will be given of the directory of the data carrier 2, since it is not relevant to the invention. In the present case, the reminder information REM forms a component of the content-type selection information CSI. It should, however, be mentioned that the reminder-data area 15 may also be located outside the two identification data SI1 and SI2 or within the recording-data area 14.

The data-carrier accessing means 11 are equipped with an accessing shaft 11A, which is designed for interaction and for enabling accessing to the data carrier 2. As shown symbolically in FIG. 1 with the aid of an arrow W, the data carrier 2 can be made accessible to data-carrier accessing means 11 in that it is introduced into the accessing shaft 11A, for example, by a user. The data-carrier accessing means 11 are further equipped with drive means, not shown in FIG. 1, which are designed for driving, in a rotatory manner, the data carrier 2 that has been made accessible.

The data-carrier accessing means 11 are further equipped with optical scanning means, not shown in FIG. 1, which are designed for optical scanning of the data carrier 2. The scanning means are further designed for receiving recording information WI, which represents information to be recorded, and, for the purpose of storing the information, are designed for writing this recording information WI in the data carrier 2. The scanning means are further designed for reading the information stored in the data carrier 2, and for generating and delivering readout information PI representing this stored information.

The data-carrier accessing means 11 are designed for recognizing the identification data SI1 and SI2 stored on the data carrier 2, and for accessing the content-type selection information CSI stored in the identification-data area 13 of the data carrier 2. To this end, the data-carrier accessing means 11 are equipped with an accessing-control stage 16, which is designed for controlling the accessing, i.e. for controlling the scanning means. A data carrier 2 made accessible to the data-carrier accessing means 11 can then initially be scanned within its identification-data area 13, along the track 12; readout information PI can then be delivered from the scanning means to the accessing-control stage 16, which information PI represents the content of the identification-data area 13. The accessing-control stage 16 is further designed for recognizing the identification data SI1 and SI2 within the recording information WI, and for extracting the content-type selection information CSI from the readout information PI, and for delivering the content-type selection information CSI to the receiving means 8.

The data-carrier accessing means 11 are further designed for accessing the content-type reminder information REM, which is stored in data carrier 2 in addition to the content-type selection information CSI and which is assigned to the content-type selection information CSI. To this end, the accessing-control stage 16 is designed for recognizing the reminder information REM in the readout information PI, and for extracting the reminder information REM from the readout information PI, and for delivering the reminder information REM to the receiving means 8.

The data-carrier accessing means 11 are further designed for recording, along the track 12, the received content signal CS on the data carrier 2, that can be made accessible to them, in the form of recording data RD within the recording-data area 14. In this context, the data-carrier accessing means 11 realize recording means 11B of the device 1, with the aid of which, taking account of a recording-control signal RCS, recording of a content signal CS, which can be received with the aid of the receiving means 8, can be undertaken in a controllable manner on the data carrier 2. To this end, the accessing-control stage 16 is designed for receiving the recording-control signal RCS. The accessing-control stage 16 is further designed for receiving the recording data RD and, for the purpose of storing the recording data RD when the recording-control signal RCS is present, for generating and delivering to the scanning means the recording information WI which represents the recording data RD.

For the sake of completeness, it should be mentioned at this point that the data-carrier accessing means 11 realize reproduction means 11C, which are designed for reproducing recording data RD stored in the recording-data area 14. To this end, the accessing-control stage 16 is designed for controlling the scanning means for the purpose of generating the readout information PI which, in the present case, represents the recording data RD stored in the recording-data area 14. The accessing-control stage 16 is further designed for delivering reproduction data WD which represents this readout information PI.

The device 1 is further equipped with signal/data conversion means 18, which are designed for receiving the content signal CS that can be delivered by the receiving means 8, and for converting the content signal CS into recording data RD. The signal/data conversion means 18 are further designed for delivering the recording data RD to the data-carrier accessing means 11.

The device 1 is further equipped with data/signal conversion means 19, which are designed for receiving the reproduction data WD that can be delivered by the data-carrier accessing means 11, and for converting the reproduction data WE into a reproduction signal WS that represents this reproduction data WD. The data/signal conversion means 19 are further designed for delivering the reproduction signal WS to the reproduction means 10.

For the purpose of receiving a content signal CS, which represents a content corresponding to the content-type selection information CSI that can be input with the aid of the data-carrier accessing means 11, the receiving means 8 are equipped, in an adjustable manner, with a receiving stage 20, which is designed for receiving, with the aid of an adjusting signal C that can be fed to it, a content signal CS of this kind. The receiving stage 20 is realized by an electronically adjustable frequency tuning device, also referred to as a tuner for short.

The receiving means 8 are further equipped with an adjusting stage 21, which is designed for generating and for delivering the adjusting signal C for the receiving stage 20 with the aid of the content-type selection information CSI that can be input with the aid of the data-carrier accessing means 11, and the first content-type information CI1 or the second content-type information CI2 that can be fed to it.

In the case of the first content-type information CI1, the adjusting stage 21 is designed for receiving the first content-type information CI1 from the receiving stage 20 and, for the purpose of generating the adjusting signal C, for processing the first content-type information CI1. This is advantageous if the received signal S exhibits, in addition to the content signal CS, the first content-type information CI1, so that immediately at the instant of receipt of the signal S, a decision can be made at the adjusting stage 21 as to whether the content signal CS currently received represents a content, the content type of which corresponds or does not correspond to the content-type selection information CSI input with the aid of the data-carrier accessing means 11, in the event that it does not correspond, the adjusting stage 21 being designed for modifying the adjusting signal C until the state of correspondence is reached.

For the purpose of feeding the second content-type information CI2, the device 1 is equipped with a communication stage 23, which is assigned to receiving means 8 and which is designed for communicating with the content-type information database 6, and which is designed for feeding to the adjusting stage 21, as the result of a communication with the content-type information database 6, the second content-type information CI2 supplied by the content-type information database 6. This is advantageous if, in addition to the content signal CS, the received signal S exhibits no first content-type information CI1, so that, immediately at the instant of receipt of the signal S, no decision can be made at the adjusting stage 21 as to correspondence or non-correspondence; for the purpose of decision-making, recourse may then be had to the second content-type information CI2. To this end, the adjusting stage 21 is designed for recognizing the absence of the first content-type information CI1 in the received signal S. The adjusting stage 21 is further designed for generating and for delivering the request information RI to the communication stage 23, from which the second content-type information CI2 can be fed to it as the result of a communication with the content-type information data source 6. In this case, the request information RI essentially represents the transmission channel currently received and, where applicable, a broadcasting station identifier contained in the received signal S.

However, irrespective of a currently received signal S, the adjusting stage 21 is designed for generating request information RI. In this case, request information RI relates to a transmission program plan of one or more broadcasting stations. This gives rise to the advantage that the adjusting signal C can be planned ahead as regards the content-type selection information CSI that can be input with the aid of the data-carrier accessing means 11. The communication stage 23 is realized with the aid of a modem.

The receiving means 8 are further designed, taking account of the reminder information REM, for receiving a content signal CS which represents a content, the content type of which corresponds to the content-type selection information CSI. To this end, the adjusting stage 21 is designed for receiving reminder information REM from the data-carrier accessing means 11, and for taking account of the reminder information REM in the generation of the adjusting signal C. The adjusting stage 21 is designed for generating an adjusting signal C of a kind such as to prevent, in a reliable manner, the receiving of a content signal CS representing a content that corresponds to a part of a type of content represented by the reminder information REM which has already been received in the past with the aid of the content-type selection information CSI stored on the data carrier 2. This gives rise to the advantage that a repeated reception of video films assigned to a specific type of content, such as individual episodes of a series that have already been received once in the past, can be prevented in a reliable manner.

The operating mode of the device 1 is explained below with reference to an example of an application for the device 1 in accordance with FIG. 1. In accordance with this application example, let it be assumed that a user of the device 1 purchases in a shop a data carrier 2 in the form of a DVD the pilot film of the television series “Kommissar Rex” with Tobias Moretti in the main role being recorded on the data carrier 2 between the third point P3 and the fourth point P4 along the track 12 of the data carrier 2. The identification-data area 13 contains information for identifying the data carrier 2 as a DVD and for identifying the pilot film and its position along the track 12. On the data carrier 2 is further stored, between the two identification data SI1 and SI2, content-type selection information CSI which represents the television series “Kommissar Rex” as the type of content. Let us further assume that the reminder-data area 15 exhibits no reminder information REM at the time of purchase of the data carrier 2, since no receipt of a video film by the device 1 with the aid of the content-type selection information CSI has yet taken place.

The data carrier 2 is made accessible to data-carrier accessing means 11 by the user. Subsequently, a first optical scanning of the data carrier 2 is undertaken by the data-carrier accessing means 11 in order to read out, in the form of readout information PI, the information for identifying the data carrier 2 stored in the identification-data area 12.

A method in accordance with the invention is then carried out by the device 1 in order to make available the content-type selection information CSI stored in the data carrier 2; the method then exhibits the steps cited below: receipt of the content-type selection information CSI that can be input with the aid of the inputting means 9 of the device 1, for the purpose of inputting content-type selection information CSI, access being had, with the aid of the data-carrier accessing means 11 of device 1, to the content-type selection information CSI which is stored in the data carrier 2 made accessible to the data-carrier accessing means 11. Access is then had to the content-type selection information CSI stored in the identification-data area 13 of the data carrier 2, which content-type selection information CSI is restricted by the two identification data SI1 and SI2. When the content-type selection information CSI is accessed, this identification data SI1 and SI2 stored in the data carrier 2 is recognized by the access-control stage 16, and the access-control stage 16 subsequently extracts the content-type selection information CSI from the readout information PI.

The content-type selection information CSI is then delivered from the access-control stage 16 to the adjusting stage 21 of the receiving means 8. The adjusting stage 21 initially receives the first content-type information CI1, which was received with the aid of transmission signal S, and checks whether the first content-type information CI1 correponds to the content-type selection information CSI.

In the present case, let us assume that each of three different broadcasting stations broadcasts, in a transmission channel assigned to it, a transmission signal S, which can be fed to the receiving means 8 of the device 1 with the aid of the reception-antenna configuration 10. FIG. 4 shows, for a first broadcasting station BS1 and for a second broadcasting station BS2 and for a third broadcasting station BS3, the starting time of an episode from the television series “Kommissar Rex” each time along a time axis t. A first episode E1 of this television series is entitled “Flucht in den Tod”. A second episode E2 is entitled “Der Tod der alten Dame”. A third episode is entitled “Tödliche Teddys”. The starting times of the broadcasting of each of the episodes E1 to E3 are entered along the time axis t at the times T1 to T7. A repetition of the episodes E1 to E3 is identified with WE1 to WE3. Along the time axis t are further entered five time phases, which are identified with D1 to D5 and which each mark one day.

Accordingly, a first broadcast of the first episode E1 is started by the first broadcasting station BS1 on the evening of the first day D1 at the time T1. A broadcast of the repeat WE1 of the first episode E1 is started by this broadcasting station BS1 on the morning of the second day D2, at the time T2. A broadcast of the second episode E2 of this television series is started by the first broadcasting station BS1 at the time T6 after a time span of three days, referred to the time T1 of the first episode E1.

A broadcast of the second episode E2 is started by the second broadcasting station BS2 at the time T3 on the evening of the second day D2. A broadcast of the repeat WE2 of this second episode E2 is started on the morning of the fourth day D4, at the time T5.

A broadcast of the first episode E1 is started by the third broadcasting station BS3 at time T4 on the evening of the third day D3. A broadcast of the second episode E2 is started on the evening of the fourth day D4, at the time T6, and a broadcast of the third episode E3 is started on the evening of the fifth day at the time T7.

At a time T0, the data carrier 2 is made accessible to the data-carrier accessing means 11 of the device 1. At this time T0, the receiving stage 20 is adjusted to receive the transmission signal S from the broadcasting station BS1. Since, at this time T0, the first content-type information CI1 transmitted by the broadcasting station BS1 along with the transmission signal S does not correspond to the content-type selection information CSI, request information RI is generated by the adjusting stage 21 and delivered to the communication station 23. The communication stage 23 then communicates, via data network 7, with the content-type information data source 6 and, as the result of this communication, feeds the second content-type information CI2 to the adjusting stage 21. The second content-type information CI2 exhibits the information that is needed at the adjusting stage 21 in order that planning can be undertaken for the adjusting signal C so that, with the aid of the receiving stage 20, a content signal CS can be received which represents a content, the content type of which corresponds to the content-type selection information CSI. Specifically, all information regarding the broadcasting station in question, BS1 to BS3, and the times in question, T1 to T7, is fed to the adjusting stage 21 with the aid of the content-type information CI2. Subsequently, a plan for the adjusting signal C is undertaken by the adjusting stage 21 as discussed below: at the time T1, the receiving stage 20 is adjusted in such a way that the signal S broadcast by the first broadcasting station BS1 is received. Following this adjustment, at the time T3 the receiving stage 20 is adjusted, as indicated by an arrow 25, so that the transmission signal S broadcast by the second broadcasting station BS2 is received. Following this adjustment, at the time T7 the receiving stage 20 is adjusted, as indicated by an arrow 26, so that the transmission signal S broadcast by the third broadcasting station BS3 is received.

Through the provision of this plan with the aid of the device 1 in accordance with the invention, it is ensured that, without any intervention on the user's part, the user is always supplied with the latest episodes E1, E2 and E3 of the television series “Kommissar Rex” and that any reception of repeats WE1 to WE2 is suppressed, in the present case it being assumed that the data carrier 2 is not removed from the data-carrier accessing means 11 during the five days D1 to D5. It is further ensured that any reception of the broadcasts of the episodes E1 and E2 taking place between the time T3 and the time T7 is prevented.

To deal with the eventuality that, for example at the time TOA, the data carrier 2 is removed from the data-carrier accessing means 11, provision is made in respect of device 1 for reminder information REM to be stored within the reminder-data area 15 of the data carrier 2 with the aid of the data-carrier accessing means 11, which reminder information indicates that, in the past—at the time T1 in the present case—the first episode E1 entitled “Flucht in den Tod” has already been received by the device 1 with the aid of the content-type selection information CSI stored on the data carrier 2. It should be mentioned at this point that provision may also be made for the appropriate reminder information REM to be stored in the data carrier 2 immediately after or during or at the start of the reception of one of the episodes E1 to E3.

To deal with the eventuality that, at the time TOB—i.e. before the broadcasting of the repeat WE1 of the first episode E1 takes place at the time T2—the data carrier 2 has again been made accessible to the data-carrier accessing means 11, provision is made in the method in accordance with the invention for making available the content-type selection information CSI for access to be had to the—now already available—reminder information REM. Owing to the data carrier 2 having again been made accessible, a new plan takes place at the adjusting stage 21 for adjusting the signal C by analogy with the procedure previously described. In the present case, however, the reminder information REM delivered by the access-control stage 16 to adjusting stage 21 is taken into account to the extent that the repetition WE1 of the first episode E1 is ignored at the time T2, and that the adjusting stage 20 is adjusted at the time T3 for receiving the transmission signal S assigned to the second broadcasting station BS2. The receiving stage 20 is further adjusted at the time T7 for receiving the signal S assigned to the third broadcasting station BS3. It is thereby reliably ensured for the user that the uninteresting repetitions WE1 to WE3 of the individual episodes E1 to E3 are not received by the device 1; this happens in an advantageous manner, even if the data carrier 2 is not made accessible to data-carrier accessing means 11 in the meantime, that is, during the time interval T0A to T0B in the present case.

Provision is further made in the device 1 for episodes E1, E2 or E3, received with the aid of content-type selection information CSI, to be recorded on the data carrier 2 at the wish of the user of the device with the aid of the data-carrier accessing means 11. To this end, the device 1 is controlled by the user of the device 1 in a recording mode in a conventional manner once the data carrier 2 has been made accessible. In this recording mode, the recording-control signal RCS is delivered to the data-carrier accessing means 11 by the adjusting stage 21 if the content type assigned to the content of the received content signal CS corresponds to the content-type selection information CSI. As soon as the access stage 16 of the data-carrier accessing means 11 receives the recording-control signal RCS, the recording data RD generated with the aid of the signal/data conversion means 18 is delivered to the optical scanning means of the data-carrier accessing means 11 in the form of the recording information WI and recorded by the scanning means within one of the free areas of the track 12 of the data carrier 2 after the fourth point P4. In the present case an input identifying the episode recorded in each case is again noted in the reminder-data area 15 of the data carrier 2. Above all, this offers the user the advantage that an archive of video films of only one sort as regards type of content can be built up on the data carrier 2.

The device 1 shown in FIG. 3 is realized by an audio recording/reproduction device, which is designed for receiving and recording or reproducing audio information, and for delivering audio information of this kind to reproducing means 10; in the present case reproducing means 10 are realized by a power amplifier with loudspeakers connected to the power amplifier. By contrast with the device 1 shown in FIG. 1, the receiving stage 20 of the device 1 shown in FIG. 3 is designed for receiving a content signal CS via the data network 7. In the present case, the data network 7 is realized by a cable television network via which television programs and radio programs and Internet-related data can be transmitted simultaneously. The broadcasting station 3 is connected to this data network 7 and is designed for broadcasting the content signal CS via the data network 7.

The device 1 is equipped with a hard disk that realizes the recording means 24, which hard disk is designed for storing the recording data RD and for reproducing the reproduction data WD. The storage means 24 realize the recording means 11B and are designed for receiving the recording-control signal RCS, as a result of which the recording on the hard disk of a content signal CS that can be received with the aid of the receiving means 8 can be undertaken in a controllable manner.

In the present case, the data-carrier accessing means 11 are designed in a contactless manner for accessing content-type selection information CSI stored in the data carrier 2 for the purpose of inputting the content-type selection information CSI into device 1. The data-carrier accessing means 11 are equipped for this purpose with an accessing-means interface which is designed for communicating with infrared light but is not shown in FIG. 3.

In the present case, the data carrier 2 is realized with the aid of a semiconductor memory which is equipped with means for contactless communication. To this end, the data carrier 2 is equipped with a data-carrier interface designed for communicating with infrared light, which is not shown in FIG. 3; this interface is designed for interacting with the accessing-means interface.

In the present case too, this gives rise to the advantage that the content-type selection information CSI can be input by simply making the data carrier 2 of the device 1 accessible to the data-carrier accessing means 11.

As a result of the design of the data carrier 2 in accordance with the second embodiment of the invention, the further advantage is obtained that this data carrier 2 can be of a relatively small and handy design, making it suitable as, for example, a key-fob, so that it can be used both domestically and also in a motor vehicle or in a portable device. This gives rise to the advantage for the user that the user can match the device designed for receiving a content signal CS to the user's needs, i.e. to a preferred type of content, in the easiest way possible.

In connection with the contactless communication, it can further be mentioned that communication based on capacitive or inductive means can also be provided.

It should be mentioned that, in the above embodiments, reference is always made to a single item of content-type selection information CSI stored in a data carrier 2. Naturally, a plurality of these may also be stored on a data carrier 2. It can further be provided that the data-carrier accessing means 11 may be designed for simultaneously or sequentially accessing a plurality of data carriers 2. In this connection, it can further be provided that the device 1 can offer the user a selection option for selecting one of the plurality of items of content-type selection information CSI stored on a single or on a plurality of data carriers 2.

It should further be mentioned that the reminder information REM may also contain reproduction information which indicates whether, or how often, a video film currently recorded on the data carrier 2 has been played back. In this connection, it may further be provided in respect of the device 1 that overwriting of a video film that has not yet been played back is prevented. As a result, it is possible for a pool of video films that is always kept up to date as regards its type of content to be available on a data carrier 2; a selective overwriting of video films may then take place, taking account of the reproduction information.

It should further be mentioned that the device 1 may be designed in a controllable manner, depending on the content-type selection information CSI that can be input to it, for matching its audio-reproduction response and/or its video-reproduction response to the particular content type and/or for supplying display options, such as special menu items or links to Internet sites, if receiving means 8 receive a content signal CS that represents a content corresponding to the input content-type selection information CSI.

It should further be mentioned that the device 1 may also be designed in accordance with the requirements of a user for modifying the content-type selection information CSI stored in the data carrier 2 and, if applicable, the reminder information REM.

It should further be mentioned that the data carrier 2 may also be realized by a compact disk (CD) or by a semiconductor memory equipped with electrical connections, and that the data-carrier accessing means 11 may be designed for interacting with data carriers 2 of this kind.

It may further be mentioned that the measures taken in accordance with the invention in a device 1 and a data carrier 2, and the method in accordance with the invention, can be used for the protection of children. This is the case especially if, in the presence of content-type selection information CSI input by the data-carrier accessing means 11, which is provided in the present example for selecting a child-friendly type of content, the receiving means 8 do not enable any receiving—including manually adjusted receiving—of a content signal CS representing a content that is not assigned to a child-friendly type of content.

1. A device (1),
which is designed for processing a content signal (CS) that represents a content in accordance with a specific type of content, and
is equipped with receiving means (8) which are designed in an adjustable manner for receiving, with the aid of content-type selection information (CSI) enabling the selection of a type of content, the content signal (CS), that represents a content, the type of which corresponds to the content-type selection information (CSI), and
is equipped with inputting means (9) which are designed for inputting the content-type selection information (CSI) for the purpose of adjusting the receiving means (8),
characterized in that the inputting means (9) contain data-carrier accessing means (11), that are designed to interact with a data carrier (2) and, for the purpose of inputting the content-type selection information (CSI) into the device (1), are designed for accessing content-type selection information (CSI) stored in a data carrier (2) that can be made accessible to the data-carrier accessing means (11).

2. A device (1) as claimed in claim 1, characterized in that the data-carrier accessing means (11) are designed for recognizing identification data (SI1, SI2) stored on the data carrier (2), which identification data (SI1, SI2) is provided for identifying the content-type selection information (CSI).

3. A device (1) as claimed in claim 1, characterized in that the data-carrier accessing means (11) are designed for accessing content-type selection information (CSI) stored in an identification-data area (13) of the data carrier (2), the identification-data area (13) being provided for identifying the data carrier (2).

4. A device (1) as claimed in claim 1, characterized in that the data-carrier accessing means (11) are designed for accessing reminder information (REM) assigned to content-type selection information (CSI), which reminder information (REM) is stored, additionally to the content-type selection information (CSI), in a data carrier (2) that can be made accessible to the data-carrier accessing means (11) and represents a part of a type of content, the part of the type of content already having been received by the receiving means (8), using the content-type selection information (CSI), with the aid of a content signal (CS) which represents a content, the content type of which corresponded to the content-type selection information (CSI), and that the receiving means (8) are designed for receiving, taking account of the reminder information (REM), a content signal (CS), the content type of which corresponds to the content-type selection information (CSI).

5. A device (1) as claimed in claim 1, characterized in that the receiving means (8) are equipped with a receiving stage (20) which is designed, in an adjustable manner, for receiving a content signal (CS) with the aid of an adjusting signal (C) that can be fed to it, and
that the receiving means (8) are equipped with an adjusting stage (21) which is designed for generating and delivering the adjusting signal (C) for the receiving stage (20) with the aid of content-type selection information (CSI) and content-type information (CI1, CI2) that can be fed to it, the content-type information (CI1, CI2) representing a content type of a content signal (CS) that can be received with the aid of the receiving stage (20).

6. A device (1) as claimed in claim 5, characterized in that content-type information (CI1, CI2) can be fed to the adjusting stage (21) with the aid of a content signal (CS) that can be received.

7. A device (1) as claimed in claim 5, characterized in that a communication stage (23) is assigned to the receiving means (8), which communication stage (23) is designed for communicating with a content-type information data source (6), the content-type information data source (6) being provided for supplying content-type information (CI2), and which is designed for feeding content-type information (CI2) supplied by the content-type information data source (6) to the adjusting stage (21) as a result of a communication with the content-type information data source (6).

8. A device (1) as claimed in claim 1, characterized in that recording means (11B) are provided, with the aid of which, taking account of a recording control signal (RCS), a recording can be made in a controllable manner of a content signal (CS) that can be received with the aid of the receiving means (8), and that the receiving means (8) are designed for generating and delivering the recording control signal (RCS) to the recording means (11B) if the content type of the content of the content signal (CS) received corresponds to the content-type selection information (CSI).

9. A device (1) as claimed in claim 8, characterized in that the recording means (11B) are realized by the data-carrier accessing means (11), and
that the data-carrier accessing means (11) are designed for recording the content signal (CS) on a data carrier (2) that can be made accessible to them.

10. A data carrier (2),
in which accessible information is stored,
characterized in that at least parts of the stored information form content-type selection information (CSI) which, when the data carrier (2) is made accessible to data-carrier accessing means (11) of a device (1) for processing a content signal (CS), can be accessed with the aid of the data-carrier accessing means (11) for the purpose of inputting the content-type selection information (CSI) into the device (1).

11. A data carrier (2) as claimed in claim 10, characterized in that identification data (SI1, SI2) is stored in the data carrier (2), which identification data (SI1, SI2) is provided for identifying the content-type selection information (CSI).

12. A data carrier (2) as claimed in claim 10, characterized in that the content-type selection information (CSI) is stored in an identification-data area (13) of the data carrier (2), which identification-data area (13) is provided for identifying the data carrier (2).

13. A data carrier (2) as claimed in claim 10, characterized in that the data carrier (2) is equipped with a reminder-data area (15) which is provided for storing reminder information (REM) which represents a part of a type of content of a content signal (CS), the part of the type of content already having been received in the past, with the aid of the content-type selection information (CSI), by the receiving means (8), with the aid of a content signal (CS) which represents a content, the content type of which corresponded to the content-type selection information (CSI).

14. A method for making available content-type selection information (CSI) in a device (1) for processing a content signal (CS) that represents a content that is assigned to a specific content type, the method comprising the following steps:
receipt of content-type selection information (CSI) which can be input with the aid of inputting means (9) on the device (1), a content signal (CS) being receivable in an adjustable manner by receiving means (8) on the device (1) with the aid of content-type selection information (CSI) that can be input, which content signal (CS) represents a content, the type of which corresponds to the content-type selection information (CSI),
characterized in that, for the purpose of inputting the content-type selection information (CSI) with the aid of the data-carrier accessing means (11) of the device (1), content-type selection information (CSI), stored in a data carrier (2) that can be made accessible to the data-carrier accessing means (11), is accessed.

15. A method as claimed in claim 14, characterized in that, when the content-type selection information (CSI) is accessed, identification data (SI1, S12) stored in a data carrier (2), which identification data is provided for identifying the content-type selection information (CSI), is recognized.

16. A method as claimed in claim 14, characterized in that content-type selection information (CSI) stored in an identification-data area (13) of the data carrier (2) is accessed the identification-data area (13) being provided for identifying the data carrier (2).

17. A method as claimed in claim 14, characterized in that reminder information (REM) is accessed, which reminder information (REM) represents one part of a type of content, the part of the type of content already having been received, using the content-type selection information (CSI), with the aid of a content signal (CS) which represents a content, the content type of which corresponded to the content-type selection information (CSI).
